(19) United States
(12) Patent Application Publication
(10) Pub. No.: US 2002/0101614 A1
(43) Pub. Date: Aug. 1, 2002

(54) Text only feature for a digital copier

(76) Inventor: Edward Peter Imes, Ontario, NY (US)

Correspondence Address: Geza C. Ziegler, Perman & Green, LLP, 425 Post Road, Fairfield, CT, 06430, US

(21) Appl. No.: 09/772,126

(22) Filed: Jan. 29, 2001

(51) Int. Cl. G06K 15/02; G06K 9/00; G06F 15/00; H04N 1/40; G06K 9/34

(52) U.S. Cl. 358/1.18; 358/462; 382/176; 358/1.11; 382/181

(57) ABSTRACT

A document reproduction system comprises an electronic reprographic apparatus and a controller. The controller includes an image manipulation device adapted to screen out unwanted images from a document being reproduced.

### BACKGROUND OF THE INVENTION

1. Field of the Invention

The present invention relates generally to an electronic reprographic system and, more particularly, to a text only feature for an electronic reprographic system.

2. Brief Description of Related Developments

The making of multiple digital copies of a complex original containing text, halftones, solids, borders and/or firms, is not an unusual event. However, in many cases it is only the text that is of importance. Copying of the total document while capturing the text also captures the non-critical elements such as borders and frames at a cost of increased toner usage. It would be helpful to be able to save money on toner while providing an ability to capture and print the essential contents of a document.

### SUMMARY OF THE INVENTION

The present invention is directed to, in a first aspect, a document reproduction system. In one embodiment, the system comprises an electronic reprographic apparatus and a controller. The controller includes an image manipulation device adapted to screen out unwanted images from a document being reproduced.

In a second aspect, the present invention is directed to a method of reproducing a document. In one embodiment, the method comprises submitting a print job to a printing system that includes the document to be reproduced. Text in the document is electronically separated from images in the document and only the text in the print job is printed.

In another aspect, the present invention is directed to a reprographic system. In one embodiment, the system comprises a first processing unit for receiving a print job and a second processing unit coupled to the first processing unit for processing the print job. A text only device is operatively coupled to the second processing unit and adapted to format the print job into a text only format. An image output terminal is operatively coupled to the second processing unit and controlled by the second processing unit for printing the text only format of the print job.

### BRIEF DESCRIPTION OF THE DRAWINGS

The foregoing aspects and other features of the present invention are explained in the following description, taken in connection with the accompanying drawings, wherein:

FIG. 1 is a block diagram of a system incorporating features of the present invention.

FIG. 2 is a block diagram of another embodiment of a system incorporating features of the present invention.

FIG. 3 is block diagram of an example of a control for the system illustrated in FIG. 1.

FIG. 4 is a flowchart illustrating one embodiment of a method incorporating features of the present invention.

### DETAILED DESCRIPTION OF THE PREFERRED EMBODIMENT

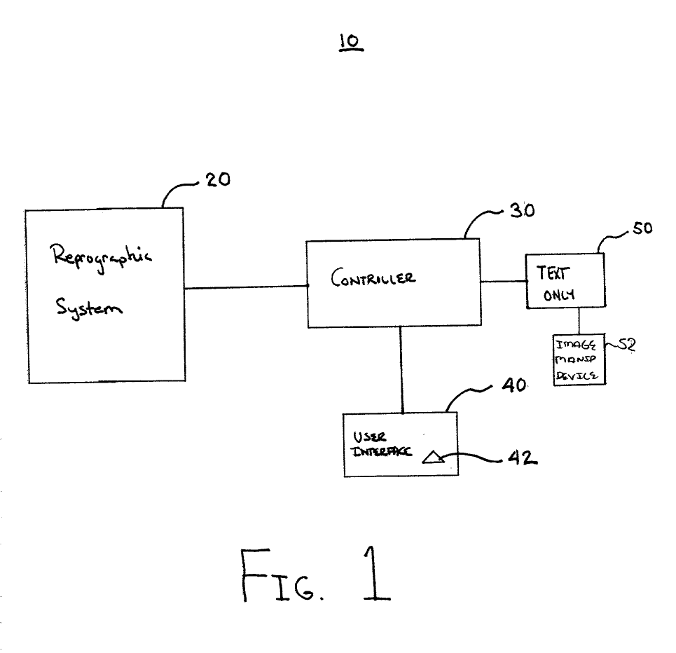

Referring to FIG. 1, there is shown a block diagram of a system 10 incorporating features of the present invention. Although the present invention will be described with reference to the single embodiment shown in the drawings, it should be understood that the present invention can be embodied in many alternate forms of embodiments. In addition, any suitable size, shape or type of elements or materials could be used.

As shown in FIG. 1, the system 10 generally comprises an electronic reprographic device 20, and a controller 30. The controller 30 includes a text only device 50 that is adapted to cause the system 10 to print only text from a document when a text only feature is selected. In alternate embodiments, the system 10 could also include other components suitable for printing only the text portion of a document. It is a feature of the present invention to separate text from other images in the document that is to be reproduced. The system 10 could also include a user interface 40 that allows system feature selection and is adapted to allow a user to input command and execution instructions associated with a print job to the system 20. The “text only” feature could be accessed from the user interface 40. The user interface 40 can be a standalone device such as for example a graphical user interface (GUI) or an integral component of the controller 30 or device 20. In one embodiment, the user interface 40 also includes a button or key 42 that can allow the user to select the “text only” option or feature. The key 42 could comprise a hard key or a soft key.

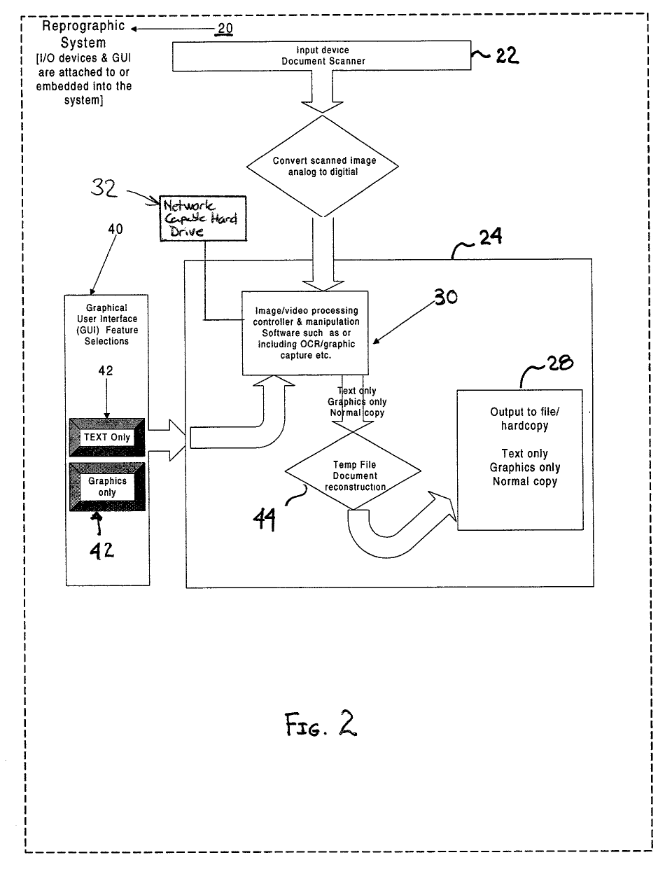

Referring to FIG. 2 the system 20 can generally comprise a reprographic imaging system, such as for example a digital copier. One example of such a system is described in U.S. Pat. No. 6,057,930, which is commonly assigned to the assignee of this application and incorporated herein by reference. Generally, the system 20 can include any conventional copying and/or printing system. The system 20 can include a number of associated components, such as for example an input device 22, such as for example an image input terminal (IIT) or document scanner that is adapted to scan a document and convert the scanned image from analog to digital, and an image processing system (IPS) 24 that can include a raster output scanner (ROS) and an image/output terminal (IOT) (not shown). The IIT generally scans the document and converts an optical image into electrical analog voltage data. The IPS 24 can be generally adapted to convert the analog digital data as well as correct, manipulate and process the digital data. The ROS can expose the charged drum to create the latent image for creating the output document.

As shown in FIG. 2, in one embodiment, the reprographic system 20 could include input/output devices and a graphical user interface 40 that is attached to or embedded in the system 20. The graphical user interface 40 can include feature selection keys or buttons 42. The feature selection keys can include “hard” keys or “soft”, programmable keys. For example, as shown in FIG. 2, selection keys 42 could include a “TEXT Only” button and a “Graphics only” button.

As shown in FIG. 2, the processing system 24 could include the controller 30. In one embodiment, the controller 30 could comprise an image/video-processing controller and include manipulation software, such as for example, optical character recognition software and graphic capture software. In an alternate embodiment, the controller 30 could include any suitable software or control hardware adapted to facilitate the separation of text from images in a file or document.

Additional features can include for example, a network capable hard drive 32 accessible via the GUI/network 40 and an output storage device 28. The output storage device 28 could include for example, a removable media drive.

Referring to FIG. 2, the controller 30 generally comprises any conventional controller adapted to interface with the system 20 and allow instructions for printing the job to be inputted into the system 20. The user interface 40 can comprise any conventional interface adapted to allow a client or user to input instructions to the controller 30.

In accordance with the features of the present invention the controller 30 is also adapted to allow the user to select a text only option or feature for printing a document. In one embodiment, upon receiving an appropriate instruction, the controller 30 is adapted to command the reprographic system 20 to reproduce or print only a text or image portion of the document. For example, after scanning data images off a document, including text and other images, the device 50 can be adapted to separate the text images from other images on the document. Only the text images are then sent for printing or downloading. In one embodiment, the device 50 can include an imaging manipulation device 52, which is adapted to screen out unwanted images such as for example bitmaps, frames, borders and halftones.

The imaging manipulation device 52 could include image manipulation software that is embedded into the device 50. Generally, the image manipulation device 52 is adapted to distinguish, capture and output to a text only editable document/file, from a document that may include text/graphics and tables. The image manipulation device may also be adapted to capture and maintain format and graphics and tables in addition to text. In one embodiment, the imaging manipulation device 52 could include optical character recognition (“OCR”) device or software. An example of such OCR software is TextBridge™ from ScanSoft™, a Xerox Corp. company. This program could be included or embedded into a system such as for example a digital copier, and used to filter unwanted graphics, borders or other boilerplate. These programs can generally receive a document input from a scanner or an existing image file. Each page is analyzed using OCR, the recognized text is collected and stored in a temporary file until all pages have been recognized. The recognized text is converted into a desired format and saved. Page layout and pictures are retained if the user selects a format for a text application that supports them.

Alternatively, in one embodiment, the system could be used to screen text and then print only images. For example, the device 50 can be adapted to identify the text in a document or print job and then send only the images such as for example the borders, frames and pictures text for printing.

Generally, the text only device 50 includes sufficient processor capability, memory and optical character recognition (OCR) software in the IPS to convert a scanned image into a user defined format, such as for example an editable, using a word processor, text format. The data stream could be directed to an output station for immediate hardcopy, or the document(s) could be stored in memory, a file or an accessible hard drive, which can include a floppy, a hard, virtual or CD, for example. Generally, any suitable medium that will allow later retrieval or further manipulation can be used. The file could then be accessed locally or over any conventional network connection such as for example a LAN or the Internet.

In one embodiment, selection of the text only feature of device 50 can generate a bit map representation of the image. It may not always be desirable to have an editable document. In most cases, text characters are of a uniform density, black and white for example, or binary versus gray scale images. The scanner thresholds can be adjusted to recognize binary formats only. The output could then be a bit map representation of the document, one that is readable, but not necessarily content editable.

The text only feature of device 50 could also be adapted to inhibit the printing of information in excess of a defined size in a scanned document. The images could be scanned and then those images that exceed a predetermined size would not be printed or downloaded.

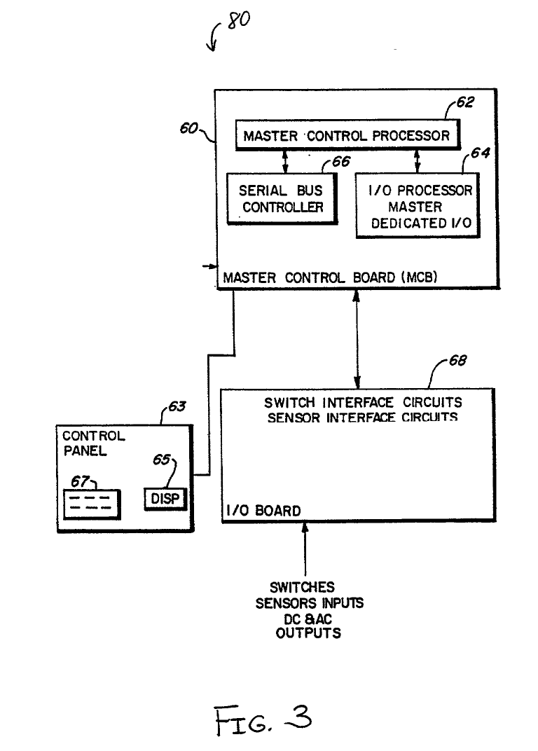

FIG. 3. generally shows an example of a control for the a system incorporating features of the present invention. The control 80 could include a master control board 60, an input/output board 68, a control panel 63 with a suitable display 65 and a system interface 67, such as for example a keyboard for entering program data or features and displaying control and selected feature information. The control 80 could be incorporated into the controller 30 shown in FIG. 1. In one embodiment, referring to FIGS. 1 and 3, the system interface 67 could for example, include the user interface 40 and feature selection 42.

The master control board 60 shown in FIG. 3 could also include a master control processor 62, a bus controller 66 and an I/O processor 64. In an alternate embodiment, the master control board 60 could include other suitable components for controlling a print job, such as selecting or deselecting features for the print job.

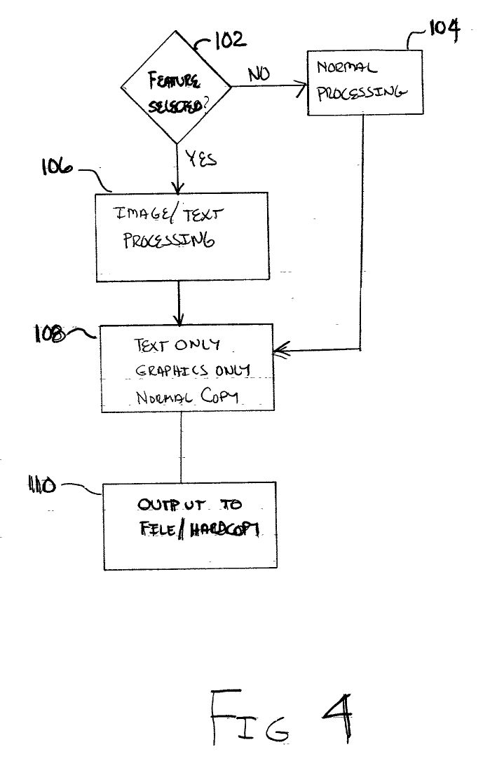

A flowchart illustrating one method incorporating features of the present invention is shown in FIG. 4. Referring to FIGS. 2 and 4, generally, the system 20 is adapted to determine 102 if a “text only” or “graphics only” feature 42 is selected for a particular print job or jobs. If the feature is not selected, the print job can be processed 104 in a conventional fashion. If a feature 42 is selected, the image and text in the document is processed 106 to separate image from text. Generally, selection of a feature 42 invokes the appropriate software within the controller to provide the desired output. The separated portions can then be segregated 108. In one embodiment, this can include storing the selected portion in a document reconstruction temporary file 44. Depending on the feature 42 selected, that portion of the document is then outputted 110. In one embodiment, the system 20 can be adapted to output the selected document portion is any suitable manner or format, such as for example, a hardcopy or file format.

The present invention generally allows text or unwanted image information to be separated out of a complex original made up of text, halftones, bitmaps, borders and frames. By incorporating optical character recognition or other image manipulation devices or software into a digital copier, a user can enable a text only feature to reproduce only the text information that is required. This can have a significant impact on the amount of ink/toner consumed and may be of particular interest to users where the cost per copy is important.

By being able to print only text, non-essential components of a document, such as for example, boilerplate, borders, pictures and illustrations can be eliminated. Since these components of a document tend to utilize toner, the “text only” feature can reduce toner consumption. When only text is desired, a multi-page document that includes pictures or other images can be reduced to a single, or fewer pages that the whole document, which can save paper. Also, when a hard copy is not required, but rather disk storage (fixed or mobile), then neither paper nor toner are used. The file can then be accessed locally or over a network.

It should be understood that the foregoing description is only illustrative of the invention. Various alternatives and modifications can be devised by those skilled in the art without departing from the invention. Accordingly, the present invention is intended to embrace all such alternatives, modifications and variances that fall within the scope of the appended claims.

What is claimed is:

1. A document reproduction system comprising:
an electronic reprographic apparatus; and
a controller, the controller including an image manipulation device adapted to screen out unwanted images from a document being reproduced.

2. The system of claim 1 wherein the controller further includes an input device adapted to allow the user to select a text only function of the image manipulation device, the text only function adapted to separate text from images in the document and send only the text to an image output device for printing.

3. The system of claim 1 wherein the image manipulation device comprises an optical character recognition system.

4. The system of claim 1 wherein the image manipulation device is adapted to separate text from images in the document and send only the text to an image output device for printing.

5. The system of claim 1 wherein the unwanted images includes borders, frames and pictures.

6. The system of claim 1 wherein the controller is adapted to screen out images that exceed a predetermined size from the document being reproduced.

7. A method of reproducing a document comprising the steps of:
submitting a print job to a printing system, the print job including the document to be reproduced;
electronically separating images on the document from text of the print job; and
printing only the text of the print job.

8. The method of claim 7 wherein the step of separating images on the document from text comprises the step of using an image manipulation device in the printing system to separate the images from the text.

9. The method of claim 7 wherein the step of separating images on the document from text comprises the step of using an optical character recognition device in the printing system to separate the image from the text.

10. A reprographic system comprising:
a first processing unit for receiving a print job;
a second processing unit coupled to the first processing unit for processing the print job;
a text only device operatively coupled to the second processing unit and adapted to format the print job into a text only format; and
a image output terminal operatively coupled to the second processing unit and controlled by the second processing unit for printing the text only format of the print job.

11. The system of claim 10 wherein the text only device is further adapted to separate images from text in the print job.

12. The system of claim 10 wherein the text only format includes only a text portion of the print job and excludes any images of the print job.

13. The system of claim 10 wherein the text only device is adapted convert a scanned image in the second processing unit into an editable text format.

14. The system of claim 10 wherein the text only device is adapted to convert the scanned image into a bitmap representation of the image.

15. The system of claim 10 wherein the text only device is adapted to inhibit a printing of information from a scanned document that exceeds a predetermined size.
